(19) United States
(12) Patent Application Publication
(10) Pub. No.: US 2004/0056020 A1
(43) Pub. Date: Mar. 25, 2004

(54) Heated patient positioning device for a medical apparatus

(75) Inventors: Gerhard Helmreich, Effeltrich (DE); Stefan Leidenberger, Effeltrich (DE)

Correspondence Address: SCHIFF HARDIN & WAITE, Patent Department, 6600 Sears Tower, 233 South Wacker Drive, Chicago, IL, 60606, US

(73) Assignee: Siemens Aktiengesellschaft

(21) Appl. No.: 10/664,743

(22) Filed: Sep. 19, 2003

(30) Foreign Application Priority Data
Sep. 19, 2002 (DE) 10243611.8

(51) Int. Cl. H05B 3/34

(52) U.S. Cl. 219/528

(57) ABSTRACT

A patient positioning device for a medical treatment or examination device, in particular for an x-ray device or computed tomography device, has a heating device to warm a patient positioned on the plate. The heating device is integrated in the positioning plate of the patient positioning device, made from a fiber composite. The heating device can be a resistive heat layer formed by current-carrying conductors. The conductor system of the resistive heat layer can be x-ray transparent, for example formed of carbon fiber textile. An imaging medical examination device, in particular an x-ray device or computed tomography device has such a patient positioning device so as to enable medical examinations over a longer period of time, since chilling of the patient is prevented.

### BACKGROUND OF THE INVENTION

1. Field of the Invention

The present invention concerns a patient positioning device for an imaging medical examination device, in particular for an x-ray device or computed tomography device. The invention also applies to an imaging medical examination device, in particular an x-ray device or computed tomography device with a patient-positioning device.

2. Description of the Prior Art

It is known from automobile technology, for example from U.S. Pat. No. 5,723,845 to use carbon conductors in seat heaters.

A problem in patient care in hospitals and in the implementation of medical examinations is that care must be taken to avoid patients becoming chilled, in particular weak patients. For this reason, passive heating measures are implemented, for example cushions are put underneath or the room temperature is regulated. This requires the attention of the tending personnel and delays the examination.

Active heating measures such as heater blankets placed on the patients, specified for example in German published patent application 198 20 698, are likewise care-intensive.

A thermally radiating warming device for a patient suffering from hypothermia is known from German published application 42 06 284, wherein the patient is placed into a heated enclosure for heating on a standard patient bed.

A heating device for surface heating of the body of a patient, for example during a surgical procedure, is known from British Specification 2 360 922. The heating device is formed by a “heater” conductor element to supply heat and a “diffuser” conductor element to spread heat, and should prevent hypothermia of the patient. It is suggested to place the heating device in a bed cover or in a mattress.

### SUMMARY OF THE INVENTION

An object of the present invention is to effectively prevent patient from becoming chilled, or at least to retard the onset thereof for a longer time, during the course of a medical examination or treatment with an examination or treatment apparatus, and thereby also to enable examinations and medical treatments with a longer duration.

This object is inventively achieved by a patient positioning device for an imaging medical examination device, in particular for an x-ray device or computed tomography device with a positioning plate made from a fiber composite, and with a heating device to heat a patient positioned on the plate, which includes a planar heating element, the heating device being integrated into the positioning plate. The patient positioning device with the integrated heating device has the advantage that the patient is actively warmed, and providing or applying the heating device does not occupy additional time of the attending personnel. The planar heating device enables a particularly large flow of heat. In the case of x-ray devices or computed tomography devices, the planar heating device can also cover only the surface that lies in the irradiated part of the examination device. The resistive heat layer can be effected as the uppermost layer of the positioning plate. The heating device is thereby nearer to the body of the patient.

In an embodiment of the invention the heating device is a resistive heating layer that has an x-ray transparent conductor system. This also enables warming of the body parts that are examined with an x-ray device or computed tomography device. Longer examinations are thus made possible, since the patient is actively warmed. It is crucial for the heating device to be x-ray transparent and for it to have no or only a minimal influence on the image quality of the medical examination device.

Such transmissivity for x-rays is made possible, for example, by making the electrical conductors of the heating device of carbon, in particular carbon fibers. The proportion of carbon can amount to at least 50%, preferably at least 80%, and more preferably at least 99%. The conductor system also can be based, for example, on carbon polymers.

The resistive heat layer can form an uppermost layer of the patient positioning table. The heating device is thus closer to the body of the patient.

The positioning plate is preferably made of a fiber composite in which the heating device is non-detachably integrated.

The fiber composite preferably is a carbon fiber composite.

The electrical conductor of the heating device preferably is electrically isolated by the composite adhesive of the fiber composite. A compact thin positioning plate, for example a carbon fiber positioning plate in sandwich construction, has the advantage that interference with the image quality of the medical examination device is minimized.

Alternatively, the heating device of the patient positioning device can be fashioned as a removable module. This can be inserted flush into the positioning plate so as to be flush with the exterior contour thereof. The removable module can be integrated such that it can be attached, retracted, or inserted flush into the positioning plate. The modular assembly simplifies the maintenance and the hygiene of the patient positioning plate.

The object of enabling longer medical examinations and procedures also is achieved in an imaging medical examination device, in particular an x-ray device or computed tomography device, that includes a patient positioning device according to the invention.

### DESCRIPTION OF THE DRAWINGS

FIG. 1 is an end view of an imaging medical examination device according to the invention, in particular an x-ray device.

FIG. 2 is a cross-section through a patient positioning plate of the imaging medical examination device of FIG. 1 in a first exemplary embodiment,

FIG. 3 is a cross-section through a patient positioning plate of the imaging medical examination device of FIG. 1 in a second exemplary embodiment, with a removable module.

FIG. 4 schematically shows the assembly of a patient positioning plate in sandwich construction, wherein heating elements are integrated in a carbon fiber reinforced plastic layer.

FIG. 5 schematically shows the assembly of a patient positioning plate in sandwich construction, wherein heating elements are located between a carbon fiber reinforced plastic layer and a filling material.

FIG. 6 schematically shows the assembly of a patient positioning plate in sandwich construction, wherein heating elements are integrated in the filling material.

FIG. 7 schematically shows the assembly of a patient positioning plate in sandwich construction, wherein heating elements are located between a Resopal layer and a filler material.

### DESCRIPTION OF THE PREFERRED EMBODIMENTS

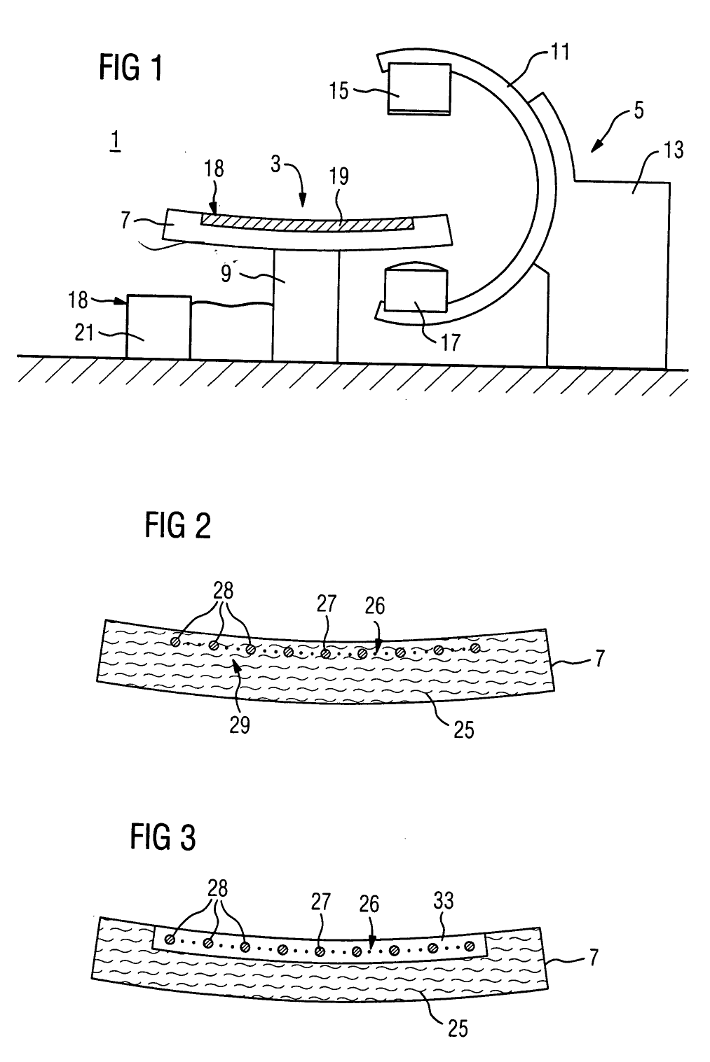

In FIG. 1, an examination installation 1 is shown that has a patient positioning device 3 and an examination unit 5, specifically an x-ray device. The patient positioning device 3 has a patient positioning plate 7 and a column or a movable mounting 9 for the patient positioning plate 7. The examination unit 5 has comprises a C-arm 11 mounted on the floor via a mounting 13. An x-ray source 15 and a radiation detector 17 are disposed at the opposite ends of the C-arm 11. The irradiation of the patient ensues between the x-ray source 15 and the detector 17.

A heating device 18 associated with the patient positioning device 3 has a heating element 19 and a control unit 21 for the heating element 19. The control unit 21 also can be integrated into the movable mounting 9 of the patient positioning plate 7.

FIG. 2 shows a section through the patient positioning plate 7 of FIG. 1. The patient positioning plate 7 is assembled as a fiber composite 25, for example a carbon or glass fiber composite, in particular in sandwich construction. A resistive heat layer 26 is integrated into the fiber composite 25. The control unit 21 controls the current flow through the resistive heat layer 26. It regulates the current and thereby the temperature of the top of the positioning plate 7, for example with a temperature sensor integrated into the patient positioning plate 7.

The resistive heat layer 27 can be implemented as the uppermost layer of the patient positioning plate 7. The resistive heat layer 26 has a conductor system 27 with a number of electrical conductors. The electrical conductors 28 are composed of carbon, in particular carbon fibers, that are electrically isolated by the composite adhesive 29 of the surrounding composite material of the patient positioning plate 7.

In FIG. 3, a second exemplary embodiment is shown for a patient positioning plate 7 with an integrated heating device formed as a removable module 33. The patient positioning plate 7 and the removable module 33 are flush with each other. The patient positioning plate 7 can be placed into the fiber composite 25, as in the exemplary embodiment of FIG. 2. The module 33 alternatively can be itself composed of fiber composite, with the resistive heat layer 25 integrated in a fixed manner in the module 33. With use of the module 33 in the patient positioning plate 7, the connection of the heating element 19 to the control unit 21 can automatically ensue, for example via automatic plug catches or latches.

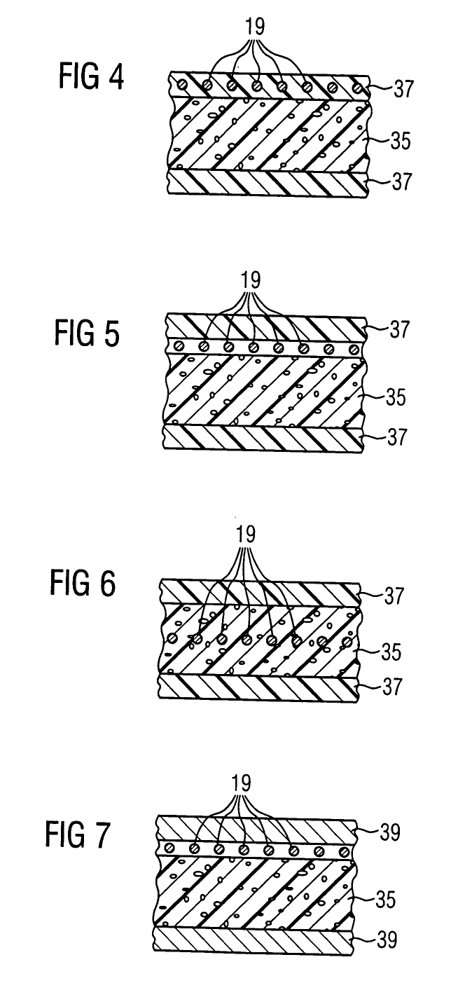

In FIG. 4, an assembly of a patient positioning plate is shown in sandwich construction. A filling material 35, for example foam, is surrounded by two carbon fiber reinforced plastic layers 37 in order to form a stable plate. In one of the carbon fiber reinforced plastic layers 37, a heating device 18 to heat the patient positioning plate is integrated by incorporating to a heating element 19 therein.

FIG. 5 shows an assembly similar to FIG. 4. Again, the filling material 35 is surrounded by the carbon fiber reinforced plastic layers 37. In this embodiment the heating element 19 is located between one of the carbon fiber reinforced plastic layers 37 and the filling material 35.

In FIG. 6, an alternative assembly similar to the FIGS. 4 and 5 is shown in which heating element 19 is integrated into the filling material 25 of a patient positioning plate.

A further alternative assembly of a patient positioning device is shown in FIG. 7 in which the filling material 35 is enclosed by two Resopal layers 39. Similar to the assembly in FIG. 5, the heating element 19 is located between the filling material 35 and one of the Resopal layers 39.

Although modifications and changes may be suggested by those skilled in the art, it is the intention of the inventors to embody within the patent warranted hereon all changes and modifications as reasonably and properly come within the scope of their contribution to the art.

We claim as our invention:

1. A patient positioning device comprising:
a patient positioning plate adapted to receive a patient thereon to position the patient for interaction with a medical apparatus;
said patient positioning plate being composed of a fiber composite; and
a heating device integrated in said patient positioning plate comprising a planar heating element adapted to interact with the patient on the patient positioning plate to warm the patient.

2. A patient-positioning device as claimed in claim 1 wherein said heating device is non-removably integrated in said patient positioning plate.

3. A patient positioning device as claimed in claim 1 wherein said heating device comprises a module adapted to be removably inserted in said patient positioning plate so as to be flush with an exterior contour of said patient positioning plate.

4. A patient-positioning device as claimed in claim 1 wherein said fiber composite is a carbon fiber composite.

5. A patient-positioning device as claimed in claim 1 wherein said heating device comprises an electrical conductor disposed in said fiber composite and electrically isolated from said fiber composite by a composite adhesive.

6. A patient-positioning device as claimed in claim 1 wherein said heating device comprises a resistive heating layer formed by a conductor system that is transparent to x-rays.

7. A patient-positioning device as claimed in claim 1 wherein said heating device is comprised of carbon.

8. A patient-positioning device as claimed in claim 7 wherein said heating device is comprised of carbon fibers.

9. A medical device comprising:
a unit adapted to receive a patient therein for interacting with the patient for a medical purpose selected from the group consisting of examination and treatment;
a patient-positioning device adapted to move a patient into and out of said unit, said patient positioning device comprising a patient positioning plate adapted to receive a patient thereon;
said patient positioning plate being comprised of a fiber composite; and
a heating device integrated into said patient positioning plate, said heating device comprising a planar heating element adapted to interact with the patient on the patient positioning plate to warm the patient.

10. A medical device as claimed in claim 9 wherein said unit is an x-ray examination device.

11. A medical device as claimed in claim 9 wherein said unit is a computed tomography device.
